(19) United States
(12) Patent Application Publication
(10) Pub. No.: US 2007/0114197 A1
(43) Pub. Date: May 24, 2007

(54) Wire shelf having integrated hooks with hanger rod

(76) Inventor: Lee E. Remmers, Ocala, FL (US)

Correspondence Address: Anthony G. Fussner, Suite 400, 7700 Bonhomme, St. Louis, MO, 63105, US

(21) Appl. No.: 11/653,499

(22) Filed: Jan. 16, 2007

Related U.S. Application Data
(62) Division of application No. 11/004,788, filed on Dec. 3, 2004, now Pat. No. 7,185,772.
Application No. 11/004,788 is a continuation-in-part of application No. 10/235,315, filed on Sep. 5, 2002, now Pat. No. 7,004,335.

(51) Int. Cl. A47F 5/08; A47G 29/00; A47B 96/06; A47K 1/00; E04G 3/00; E04G 5/06; F21V 21/00; F21V 35/00

(52) U.S. Cl. 211/153; 211/90.03; 248/215; 211/87.01

(57) ABSTRACT

According to various aspects of the present disclosure, various shelf embodiments are disclosed that include a rod member connected thereto using one or more hook members. In some embodiments, a shelf includes a plurality of hook members supporting a rod member so as to provide free sliding movement of clothes hangers on the rod member. The hook members may be integrally connected, such as by welding, etc., to support members of the wire shelf so as to support the rod member for use in, for example, hanging items thereon.

### CROSS-REFERENCE TO RELATED APPLICATIONS

This application is a divisional of presently allowed U.S. application Ser. No. 11/004,788 filed Dec. 3, 2004, which, in turn, is a continuation-in-part of U.S. patent application Ser. No. 10/235,315 filed Sep. 5, 2002 (now U.S. Pat. No. 7,004,335 issued Feb. 28, 2006). The disclosures of the above applications are incorporated herein by reference.

### FIELD

The present invention relates generally to wire shelf storage systems, and more particularly to a wire shelf having a hanger rod integrally connected thereto.

### BACKGROUND

The statements in this section merely provide background information related to the present disclosure and may not constitute prior art.

Efficient and organized use of building space is very desirable, particularly with respect to storage or utility space in businesses, residential homes and apartments. In particular, because of the limited or tight spaces in these locations, maximizing the amount of useable space is very important. Likewise, providing ease in access and increased user convenience is important.

With respect to closet organization and the design of closet storage units, particularly for residential use, many different options are available including, for example, different sizes and shapes of shelves, different attachment and mounting members and different storage members (e.g., wire baskets, shoe-stands and tie/belt racks, etc.). Ease in accessing stored items, such as clothing, is important. Further, ease in moving stored items to make room for other items or to access items not readily accessible, is likewise important.

It is common today to use ventilated shelving (e.g., wire or plastic, and associated components etc.) to construct storage units within closets. Typical ventilated shelving not only varies in size (e.g., different lengths and widths, etc.), and configuration (e.g., different wire mesh spacing, etc.), but may have connected thereto different storage or attachment members, including for example, a hanging shoe storage device or clothes on hangers. It is desirable for a single unit to include any such attachment or storage devices preassembled and connected thereto. In particular, and for example, having a single unit reduces installation time.

Shelving units with integrally connected storage or attachment devices are known. For example, different configurations for providing hanger rod attachments connected to wire shelving are known. But these designs are often not user friendly, such as having the hanger rod located behind the front of the wire shelf, or attached in such a manner that makes construction difficult and/or is more likely to result in failure (e.g., attachment of hanger rod assembly to a single support member). Thus, although these shelves with integrated hanger rods may provide for easier movement of items along a shelf, for example, sliding clothes on hangers, such shelves are often difficult to access or are susceptible to failure, for example, when hanging heavier, bulky items thereon.

### SUMMARY

According to various aspects of the present disclosure, various shelf embodiments are disclosed that include a rod member connected to a shelf using one or more hook members. In some embodiments, a shelf includes a plurality of hook members welded or otherwise attached to the shelf. The hook members support a horizontally extending rod member in an exemplary manner that allows continuous free slide of items, such as clothes hangers, along the rod member.

Other exemplary embodiments provide hook members for supporting a rod member from a wire shelf having a plurality of wires and support members forming a shelf deck. In one such embodiment, the hook member generally includes a first free end portion and a rod support end portion generally opposite the rod support end portion for connection to the rod member. The hook member also includes a generally straight portion for connection to at least one support member of the wire shelf. The hook member also includes at least three curved portions alternating in curvature between the first free end portion and the rod support end portion. The generally straight portion extends from the first free end portion towards a first one of said three curved portions. Other exemplary embodiments include wire shelves having such hook members connected thereto.

Additional embodiments relate to methods of supporting a rod member from a wire shelf with at least one hook member. The wire shelf may include wires and support members forming a shelf deck. The hook member may include a rod support end portion, a generally straight portion, and at least three curved portions alternating in curvature and extending from the generally straight portion towards the rod support end portion. In one exemplary embodiment, a method generally includes connecting the generally straight portion of at least one hook member to at least one support member of the wire shelf such that the generally straight portion extends in a generally horizontal direction away from said at least one support member. The method also includes connecting the rod member to the rod support end portion of the at least one hook member.

Further areas of applicability of the present invention will become apparent from the detailed description provided hereinafter. It should be understood that the detailed description and specific examples, while indicating embodiments of the invention, are intended for purposes of illustration only and are not intended to limit the scope of the invention.

### DRAWINGS

The drawings described herein are for illustration purposes only and are not intended to limit the scope of the present disclosure in any way.

FIG. 1 is a top perspective view of a shelf having an integrated rod member connected thereto according to one exemplary embodiment of the invention;

FIG. 2 is a bottom perspective view of the shown in FIG. 1;

FIG. 3 is a front elevation view of the shelf shown in FIG. 1;

FIG. 4 is a side elevation view of an exemplary hook member shown in FIG. 1;

FIG. 5 is a side cross-sectional view of the shelf shown in FIG. 1 having a hanger supported thereon;

FIG. 6 is a top perspective view of a shelf having an integrated rod member connected thereto according to one exemplary embodiment of the invention;

FIG. 7 is a bottom perspective view of the shelf shown in FIG. 6;

FIG. 8 is a top perspective view of a shelf having an integrated rod member connected thereto according to one exemplary embodiment of the invention;

FIG. 9 is a bottom perspective view of the shelf shown in FIG. 8 including an additional longitudinally extending support member according to another exemplary embodiment of the invention;

FIG. 10 is a front elevation view of the shelf shown in FIG. 8;

FIG. 11 is a side elevation view of an exemplary hook member shown in FIG. 8;

FIG. 12 is a side cross-sectional view of the shelf shown in FIG. 8 having a hanger supported thereon;

FIG. 13 is a top perspective view of a shelf having an integrated rod member connected thereto according to another exemplary embodiment of the invention; and

FIG. 14 is a bottom perspective view of the shelf shown in FIG. 13 including an additional longitudinally extending support member according to another exemplary embodiment of the invention.

### DETAILED DESCRIPTION

The following description is merely exemplary in nature and is not intended to limit the present disclosure, application, or uses. Although a shelf may be described in connection with component parts having a particular size and shape, the shelves of the present disclosure are not so limited, and the size and shape of the various component parts may be modified as needed or desired.

According to various aspects of the present disclosure, various shelf embodiments are disclosed that include a rod member connected to a shelf using one or more hook members. In some embodiments, a shelf includes a plurality of hook members welded or otherwise attached to the shelf. The hook members support a horizontally extending rod member in an exemplary manner that allows continuous free sliding of items, such as clothes hangers, along the rod member.

Other exemplary embodiments provide hook members for supporting a rod member from a wire shelf having a plurality of wires and support members forming a shelf deck. In one such embodiment, the hook member generally includes a first free end portion and a rod support end portion generally opposite the rod support end portion for connection to the rod member. The hook member also includes a generally straight portion for connection to at least one support member of the wire shelf. The hook member also includes at least three curved portions alternating in curvature between the first free end portion and the rod support end portion. The generally straight portion extends from the first free end portion towards a first one of said three curved portions. Other exemplary embodiments include wire shelves having such hook members connected thereto.

Additional embodiments relate to methods of supporting a rod member from a wire shelf with at least one hook member. The wire shelf may include wires and support members forming a shelf deck. The hook member may include a rod support end portion, a generally straight portion, and at least three curved portions alternating in curvature and extending from the generally straight portion towards the rod support end portion. In one exemplary embodiment, a method generally includes connecting (e.g., welding, etc.) the generally straight portion of at least one hook member to at least one support member of the wire shelf such that the generally straight portion extends in a generally horizontal direction away from said at least one support member. The method also includes connecting (e.g., welding, etc.) the rod member to the rod support end portion of the at least one hook member.

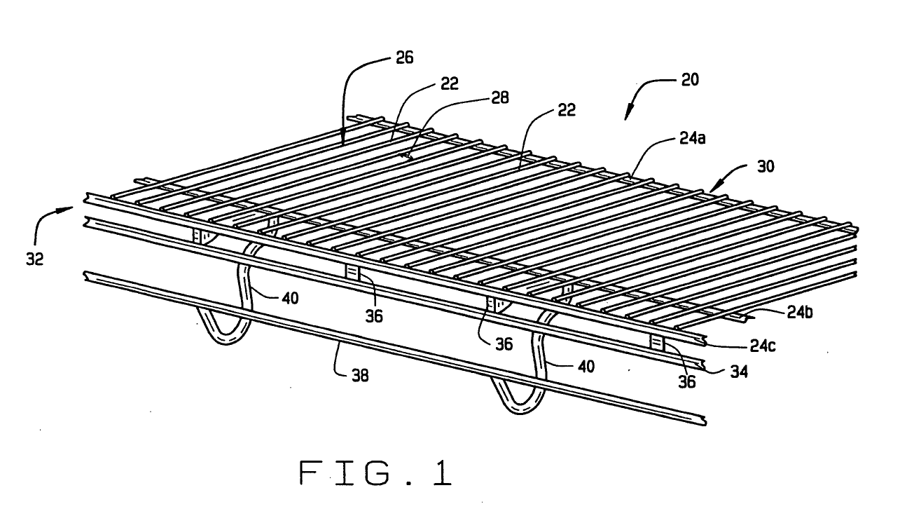

A shelf (e.g., wire shelf unit) having a rod member connected thereto with integrated hooks is shown generally in FIGS. 1 through 3 and identified by reference numeral 20. The shelf 20 generally includes a plurality of transversely extending wire members 22 (i.e., wire stringers in this embodiment) supported by a plurality of longitudinally extending support members 24 to form a shelf deck 26. The transversely extending wire members 22 are typically spaced to provide a ventilated shelf deck 26 construction while preventing relatively large items from occupying the spaces 28 between the transversely extending wire members 22.

In one of the preferred embodiments of the present invention, a plurality of longitudinally extending support members 24 are provided with one longitudinally extending support member 24a at a back or rearward end 30 (e.g., closest to a wall on which the shelf 20 is mounted, etc.), one longitudinally extending support member 24c at the front end 32 of the shelf 20, and one longitudinally extending support member 24b that is intermediate longitudinally extending support members 24a and 24c, and adjacent the front end 32. The front-most longitudinally extending support member 24c is connected to a lower longitudinally extending support member 34 with a plurality of vertically extending support members 36. A rod member 38 is connected to the shelf deck 26 (i.e., connected to the longitudinally extending support members 24b and 24c, and the vertically extending support members 36 in this embodiment) using a plurality of integrated hooks 40 as described in more detail herein.

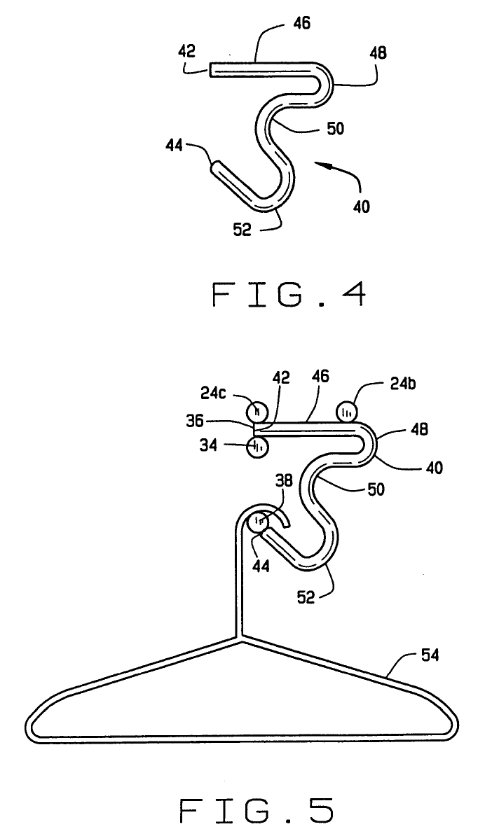

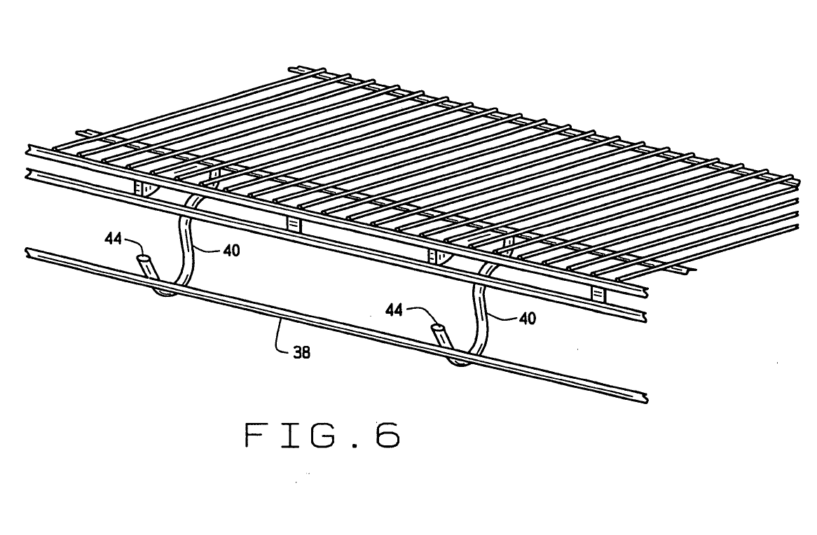

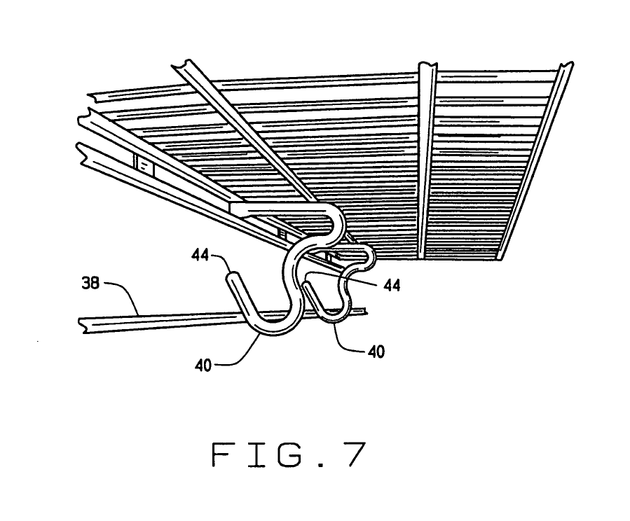

In particular, and with respect to the hook member 40 as shown in FIG. 4, it is preferably constructed as a one piece member having a first end 42 and a second end 44. The first end 42 is preferably connected to support members 36, such as by welding, etc. The second end 44 is preferably connected to the rod member 38, such as by welding, etc. It should be noted that the second end 44 may extend past the support rod 38, with the support rod 38 secured or attached at another location or point on the hook member 40, as shown in FIGS. 6 and 7. Further, in the illustrated embodiment, the hook member 40 has a generally horizontal upper portion 46 positioned below the two front-most longitudinally extending support members 24b and 24c, and connected there at its front and back ends, respectively, by welding.

In another preferred construction, the hook member 40 extends from the horizontal upper portion 46 to the second end 44. The hook member 40 is configured to have a first curved portion 48, a second curved portion 50, and a third curved portion 52. Specifically, the first and third curved portions 48 and 52 are generally configured in a concave shape relative to the front end 32 of the shelf 20. The second curved portion 50 is generally configured in a convex shape relative to the front end 32 of the shelf 20. In this exemplary embodiment, the first and second curved portions 48 and 50 are configured at about a forty five degree angle relative to the shelf deck 26, and the third curved portion 52 is configured about perpendicular to the first and second curved portions 48 and 50. The hook member is generally planar. The first end 42 and second end 44 are generally configured in the same vertical plane such that the rod member 38 is positioned generally below the lower longitudinally extending support member 34.

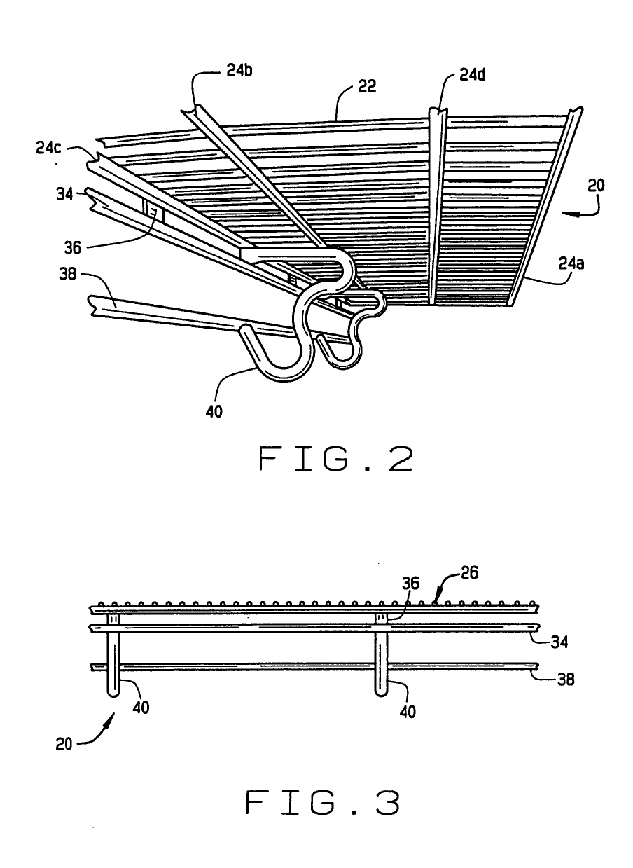

It should be noted that one or more additional longitudinally extending support members 24d may be provided, such as shown in FIG. 2 between the support members 24a and 24b. Further, the spacing of the hook members 40 and the number of hook members 40 provided may be modified based upon the particular shelf.

In an exemplary operation, the shelf 20 provides a rod member 38 integrally connected to the shelf deck 26 (i.e., two longitudinally extending support members 24b and 24c and the vertically extending support members 36 in the illustrated embodiments) with the plurality of hook members 40 such that items (e.g., clothing on hangers 54, etc.) may easily be placed and moved (e.g., slidably moved, etc.) along the rod member 38. In particular, the third curved portion 52 is configured to accommodate items, such as hangers 54, sliding along the rod member 38 as shown in FIG. 5. Further, the connection of the hook member 40 to the two longitudinally extending support members 24b and 24c and the vertically extending support members 36 provides easier manufacture of the shelf 20 (e.g., assembly of the shelf 20 to hook members 40 and rod member 38 in a single operation in some embodiments) and reduces the likelihood of failure, for example, when hanging many bulky items on the rod member 38.

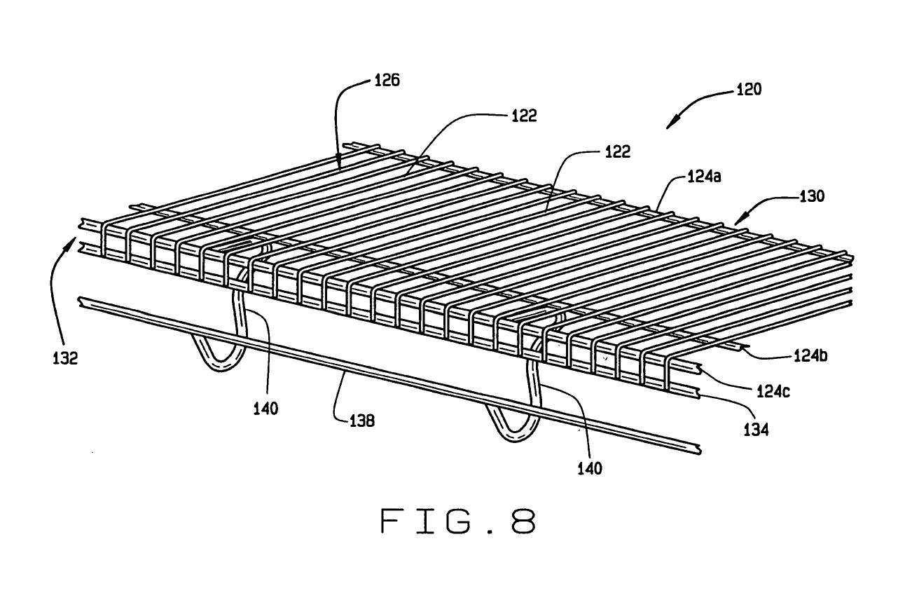

FIG. 8 illustrates another embodiment of a shelf 120 including means (e.g., hook members 140, etc.) for supporting a rod member 138. As shown, the shelf 120 generally includes a plurality of transversely extending wire members 122 supported by a plurality of longitudinally extending support members 124 to form a shelf deck 126. In this particular illustrated embodiment, the longitudinally extending support members 124 include a back support member 124a, an intermediate support member 124b, and a front support member 124c. The intermediate support member 124b is between the front and back support members 124c and 124a.

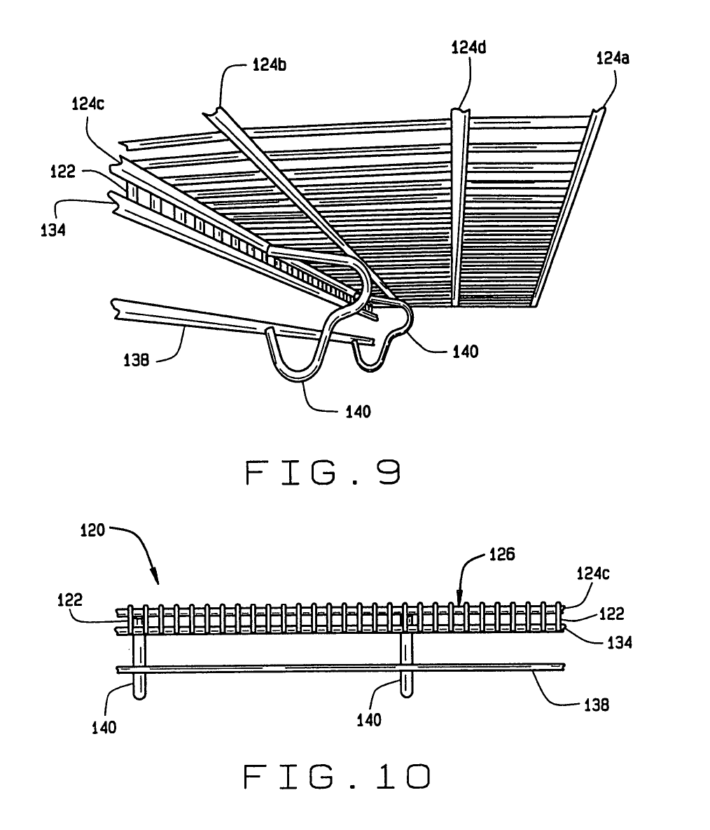

Alternatively, other configurations and arrangements for the wire members 122 and support member 124 are possible as aspects of the invention are not limited to any particular number, shape, size, and arrangement of wire members and support members. For example, one or more additional longitudinally extending support members 124d may be provided, such as shown in FIG. 9 between the support members 124a and 124b. Further, the spacing of the hook members 140 and the number of hook members 140 provided may be modified based upon the particular shelf.

With further reference to FIG. 8, the wire members 122 extend from a back or rearward end 130 (e.g., closest to a wall on which the shelf 120 is mounted) to the shelfs front end 132. In this particular embodiment, the wire members 122 extend over the front support member 124c and cascade downwardly to connect to a lower support member 134.

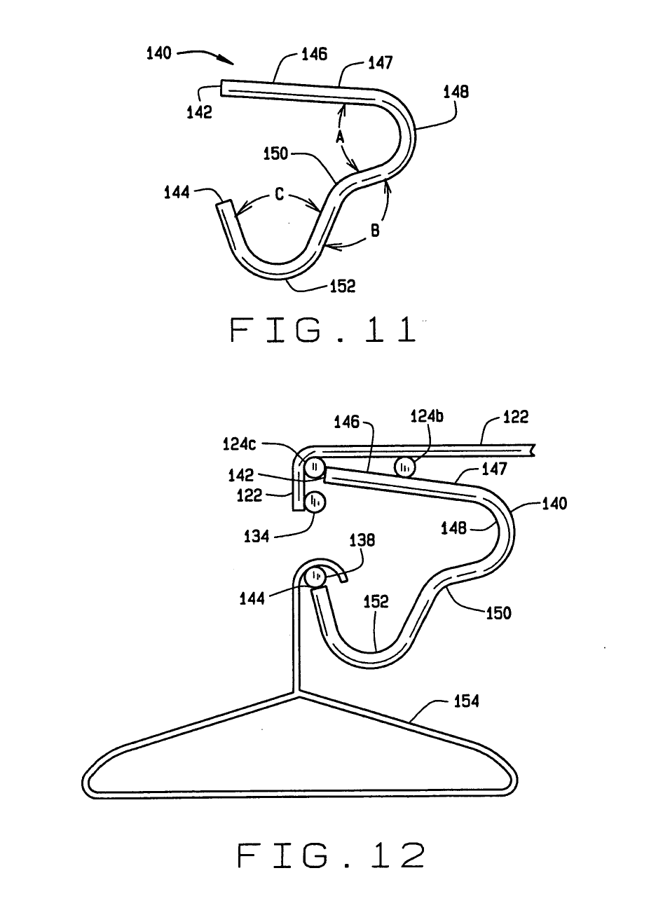

The rod member 138 is connected to the shelf deck 126 using the hook members 140. As shown in FIGS. 11 and 12, the hook member 140 includes a first end 142 and a second end 144. The first end 142 is connected to the front support member 124c, and the second end 144 is connected to the rod member 138. A wide range of suitable methods can be used to connect the first and second ends 142 and 144 to the respective front support member 124c and rod member 138, such as welding, adhesives, etc. In one exemplary embodiment, the first and second ends 142 and 144 are respectively welded to the front support member 124c and rod member 138.

With continued reference to FIG. 12, the hook member 140 has a generally horizontal upper portion 146. An upper surface 147 of the portion 146 is connected to the intermediate support member 124b. In one exemplary embodiment, the upper surface 147 is welded to the intermediate support member 124b, although other suitable fastening methods and means can be employed. In other embodiments, the upper surface of the portion 146 can also be connected (e.g., welded, etc.) to the front support member 124a instead of (or in addition to) connecting the end 142 to the front support member 124c.

Referring back to FIG. 11, the hook member 140 includes three curved portions 148, 150, and 152 that alternate in curvature extending from the horizontal portion 146 towards the second end 144. In one embodiment, the first and third curved portions 148 and 152 are generally configured in concave shape relative to the front end 132 of the shelf 120. The second curved portion 150 is generally configured in a convex shape relative to the front end 132 of the shelf 120. The third curved portion 152 is configured to accommodate items, such as hangers 154, sliding along the rod member 138 as shown in FIG. 12.

For purposes of illustration only, various dimensions will now be provided for one exemplary embodiment of the hook member 140. Referring to FIG. 11, the length of the horizontal portion 146 is about 2.85 inches (72.5 millimeters), angle A is about twenty two degrees, angle B is about one hundred thirty two degrees, and angle C is about forty three degrees. Again, however, these dimensions are for purposes of illustration only and should not be construed as limiting the scope of the present invention.

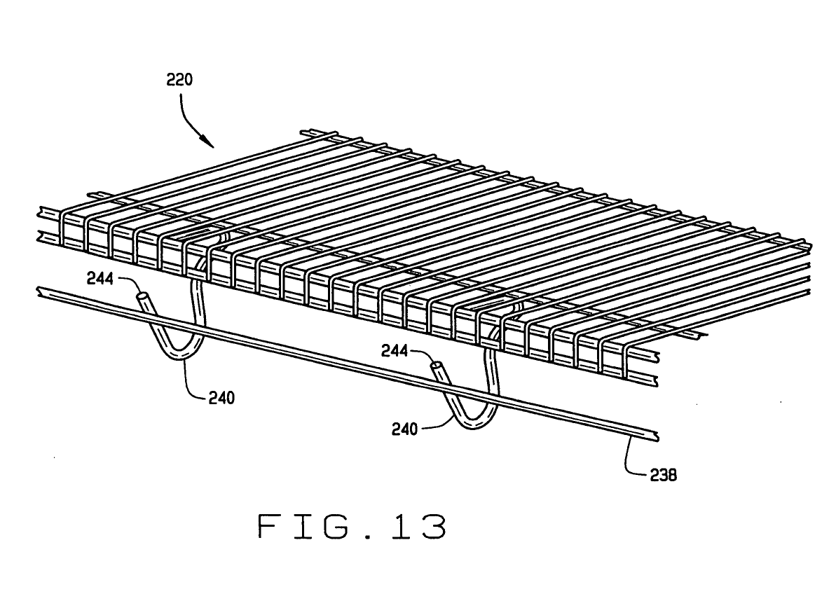

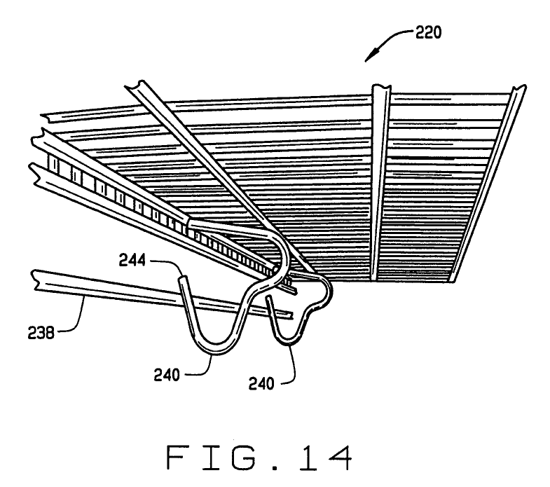

FIGS. 13 and 14 illustrate another embodiment of a shelf 220 in which the second end 244 of the hook member 240 extends past the rod member 238. As shown, the rod member 238 is secured at another point besides the end 244 of the hook member 240.

It should be noted that the hook members 40, 140, and 240 of the present invention may be provided in connection with different shelf sizes, types, and configurations and integrated therewith to provide a rod member 38, 138, 238 allowing for free sliding operation of items attached and connected (e.g., hanging, etc.) thereto.

Certain terminology is used herein for purposes of reference only, and thus is not intended to be limiting. For example, terms such as “upper”, “lower”, “above”, “below”, “top”, and “bottom” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A hook member for supporting a rod member from a wire shelf having a plurality of wires and support members forming a shelf deck, the hook member comprising:
a first free end portion;
a rod support end portion generally opposite the rod support end portion;
at least three curved portions alternating in curvature between the first free end portion and the rod support end portion; and
a generally straight portion extending from the first free end portion towards a first one of said three curved portions.

2. The hook member of claim 1, wherein the at least three curved portions comprise:
a first curved portion having a generally concave curvature relative to the first free end portion;
a second curved portion having a generally convex curvature relative to the first free end portion;
a third curved portion having a generally concave curvature relative to the first free end portion;
the second curved portion disposed between the first and third curved portions.

3. The hook member of claim 2, wherein the third curved portion is configured to allow hangers on the rod member to slide freely past the hook member without interference therefrom.

4. The hook member of claim 1, wherein the at least three curved portions comprise:
a first curved portion defining an angle A of about twenty two degrees;
a second curved portion defining an angle B of about one hundred thirty two degrees;
a third curved portion defining an angle C of about forty three degrees;
the second curved portion disposed between the first and third curved portions.

5. The hook member of claim 4, wherein:
the first and third curved portions each having a generally concave curvature relative to the first free end portion; and
the second curved portion has a generally convex curvature relative to the first free end portion.

6. The hook member of claim 1, wherein the at least three curved portions comprise:
a first curved portion opening in a direction facing generally towards the first free end portion;
a second curved portion opening in a direction facing generally away from the first free end portion;
a third curved portion opening in a direction facing generally upward relative to the first free end portion;
the second curved portion being disposed between the first and third curved portions.

7. The hook member of claim 1, wherein the at least three curved portions comprise:
a first curved portion having a generally C-shape opening in a direction facing generally towards the first free end portion;
a second curved portion having a generally U-shape opening in a direction facing generally away from the first free end portion;
a third curved portion having a generally U-shape opening in a direction facing generally upward relative to the first free end portion;
the second curved portion being disposed between the first and third curved portions.

8. The hook member of claim 1, wherein the generally straight portion has a length of about 2.85 inches thereby allowing for connection to at least two horizontally spaced-apart support members of the wire shelf disposed in a common, generally horizontal plane.

9. The hook member of claim 1, wherein the generally straight portion has a length sufficient for connection to at least two horizontally spaced-apart support members of the wire shelf disposed in a common, generally horizontal plane.

10. The hook member of claim 1, wherein the first free end portion and the rod support end portion are disposed in a common plane.

11. A wire shelf comprising wires and support members forming a shelf deck and a rod member supported by the hook member of claim 1, wherein the hook member's rod support end portion is connected to the rod member, and wherein the generally straight portion is connected to at least one of said support members of the wire shelf so as to extend in a generally horizontal direction away from said at least one support member.

12. A method of supporting a rod member from a wire shelf with at least one hook member, the wire shelf having wires and support members forming a shelf deck, the hook member having a rod support end portion, a generally straight portion, and at least three curved portions alternating in curvature and extending from the generally straight portion towards the rod support end portion, the method comprising:
connecting the generally straight portion of at least one hook member to at least one support member of the wire shelf such that the generally straight portion extends in a generally horizontal direction away from said at least one support member; and
connecting the rod member to the rod support end portion of the at least one hook member.

13. The method of claim 12, wherein connecting the generally straight portion includes connecting the generally straight portion to at least two horizontally spaced-apart support members of the wire shelf that are disposed in a common, generally horizontal plane.

14. The method of claim 13, wherein said at least two horizontally spaced-part support member include a first support member and a second support member disposed rearward of the first support member, and wherein connecting the generally straight portion includes:
connecting a first end of the at least one hook member to the first support member; and
connecting an upper surface of the generally straight portion to the second support member.

15. The method of claim 12, wherein connecting includes welding.

16. The method of claim 12, wherein, after the at least one hook member has been connected to the wire shelf, the at least three curved portions comprise:
a first curved portion having a generally concave curvature relative to a forward end of the wire shelf;
a second curved portion having a generally convex curvature relative to the forward end of the wire shelf;
a third curved portion having a generally concave curvature relative to the forward end of the wire shelf;
the second curved portion disposed between the first and third curved portions.

17. The method of claim 12, wherein the at least three curved portions comprise first, second, and third curved portions, wherein the second curved portion is disposed between the first and third curved portions, and wherein, after connecting the generally straight portion of the at least one hook member to said at least one support member:
the first curved portion opens in a direction facing generally towards the forward end of the wire shelf;
a second curved portion opens in a direction facing generally away from the forward end of the wire shelf; and
a third curved portion opens in a direction facing generally upward relative to the forward end of the wire shelf.

18. A wire shelf comprising wires and support members forming a shelf deck, a rod member, and means for supporting the rod member under the shelf deck without interfering with the sliding of clothes hangers on the rod member, said means being welded to at least two spaced-apart support members of the wire shelf that are disposed in a common, generally horizontal plane.

19. The wire shelf of claim 18, wherein the means for supporting the rod member includes at least one hook member having a rod support end portion connected to the rod member, a generally straight portion connected to said at least two spaced-apart support members, and at least three curved portions alternating in curvature and extending from the generally straight portion towards the rod support end portion.

20. The wire shelf of claim 19, wherein the at least three curved portions comprise a first curved portion having a generally concave curvature relative to a forward end of the wire shelf, a second curved portion having a generally convex curvature relative to the forward end of the wire shelf, and a third curved portion having a generally concave curvature relative to a forward end of the wire shelf, the second curved portion disposed between the first and third curved portions.
